(19) United States
(12) Patent Application Publication
(10) Pub. No.: US 2008/0201049 A1
(43) Pub. Date: Aug. 21, 2008

(54) Vehicle Brake System Having A Pump

(76) Inventor: Carsten Bodmann, Ludwigsburg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/997,261

(22) PCT Filed: Jul. 12, 2006
(86) PCT No.: PCT/EP06/64127

§ 371 Date: Jan. 29, 2008

(30) Foreign Application Priority Data
Jul. 29, 2005 (DE) 102005035595.1

(51) Int. Cl. B60T 8/00

(52) U.S. Cl. 701/70

(57) ABSTRACT

Disclosed is a vehicle brake system having a pump and a prechamber, from which the pump can extract a fluid by suction, and having a switching valve, by means of which fluid can optionally be fed to the prechamber. A bypass valve connected in parallel with the switching valve is switched as a function of the pressure difference between the ambient pressure and the prechamber pressure.

### PRIOR ART

The invention relates to a vehicle brake system having a pump and a prechamber from which the pump can aspirate a fluid, and having, a valve, by means of which fluid can be directed selectively to the prechamber.

In the field of vehicle brake systems, the most various systems are known, in which a pump is provided for active reduction or buildup of brake pressure. From a prechamber, the pump aspirates brake fluid and pumps it then selectively back to a tank to reduce brake pressure (anti-lock mode of the vehicle brake system), or (for instance in an electronic stability program) the pump pumps hydraulic fluid in the direction of the vehicle brakes.

In addition, within the hydraulic circuit into which the pump with its prechambers incorporated, a valve is also provided by means of which fluid can be selectively directed to the prechamber. In the known vehicle brake systems, when the valve is closed, low pressure can fundamentally be generated in the pump prechamber. In certain operating states of the vehicle brake system, this low pressure can become so great that in the event the valve later opens, sudden filling of the evacuated prechamber can ensue. This filling action can cause an undesirable loud noise, hammering within the pressure flow, and/or dropping of the associated brake pedal. All these side effects are unwanted.

An evacuated prechamber of a pump in a vehicle brake system can occur especially if there is a reservoir in the prechamber, and if the attempt is made to evacuate the reservoir for longer than necessary. Such an evacuation necessarily occurs often, however, because the fill level in the reservoir can only be estimated via a hydraulic model, yet on the other hand it must be assured that the reservoir is completely evacuated at certain times.

### OBJECT AND SUMMARY OF THE INVENTION

It an object of the invention to create a vehicle brake system of the type defined at the outset in which the aforementioned side effects of sudden filling of the prechamber of the pump are avoided.

The object is attained according to the invention, with a vehicle brake system of the generic type in question, in which a bypass valve is connected parallel to the valve that leads to the prechamber, and the bypass valve is switched as a function of the pressure difference between the ambient pressure and the prechamber pressure. The bypass valve of the invention makes it possible to avoid an excessively great, sudden pressure equalization via the valve leading to the prechamber in the vehicle brake system, and thus completely prevents the generation of noise or dropping of the brake pedal. The travel comfort can thus be improved, and customer complaints can be avoided.

In an advantageous refinement of the vehicle brake system of the invention, excessive evacuation of the prechamber of the pump is prevented in particular by providing a control unit which opens the bypass valve if the prechamber pressure drops below ambient pressure and closes it again if the prechamber pressure rises to or above the ambient pressure. With the control unit of this kind and the associated bypass valve, according to the invention the pressure in the prechamber of the pump of the vehicle brake system is accordingly always kept at at least the ambient pressure level.

This control unit of the invention can especially preferably be created solely with an adjuster, in particular a purely mechanical adjuster, which, actuated by the ambient pressure, pneumatically opens the bypass valve.

The control unit can moreover be designed overall without expensive sensors and actuating means by providing that the bypass valve, actuated by a simple adjuster, is furthermore closed hydraulically by the prechamber pressure. This adjuster as well can be designed as purely mechanical.

To enable using such simple adjusters, the bypass valve of the invention should furthermore be designed as a slide valve, which in particular is linearly displaceable.

The bypass valve of the invention and the thus-attained avoidance of excessive pressure equalization events in vehicle brake systems is especially advantageous in conjunction with high-pressure switching valves in hydraulic brake systems.

The invention is furthermore especially preferably employed whenever the prechamber is at least a part of a section line leading from a reservoir to the pump. If the bypass valve of the invention is associated with such a prechamber, then in particular the aforementioned sudden filling of the prechamber after a complete evacuation of the reservoir can be averted.

### BRIEF DESCRIPTION OF THE DRAWINGS

One exemplary embodiment of a vehicle brake system of the invention is described in further detail below in conjunction with the schematic drawings that follow.

FIG. 1 is a hydraulic circuit diagram of a vehicle brake system of the prior art.

FIG. 2 is a hydraulic circuit diagram of a vehicle brake system according to the invention; and

FIG. 3 is a longitudinal section through a bypass valve of the invention in the vehicle brake system of FIG. 2.

### DETAIL DESCRIPTION OF THE EXEMPLARY EMBODIMENT

In FIG. 1, the hydraulic circuit diagram of a vehicle brake system 10 in accordance with the prior art is shown. The vehicle brake system 10 contains a brake actuation unit 12, which in the conventional way includes a brake pedal 14, a brake booster 16, a master cylinder 18, and a brake fluid reservoir 20.

Two lines 22a and 22b, each belonging to one of two separate brake circuits, are connected to the master cylinder 18 and to the brake fluid reservoir 20 located there. These two brake circuits are constructed substantially identically and are hereinafter distinguished by the use of the reference letters “a” and “b”. For the sake of simplification, the following description will be limited to the first of these two brake circuits, and it is assumed that the other brake circuit, as noted, is structurally essentially identical.

The line 22a splits into two lines 24a and 26a, to which a high-pressure switching valve 28a and a low-pressure switching valve 30a, respectively, are connected. The high-pressure switching valve 28a leads with a line 32a to a prechamber 34a, which belongs to a pump 36a. The pump 36a, driven by a motor 38a, pumps into a line 40a, which is connected on one end to the low-pressure switching valve 30a and also leads to wheel brake cylinder inlet valves 42a and 44a. Connected to the wheel brake cylinder inlet valves 42a and 44a is a respective wheel brake 46a and 48a, whose return lines lead to two wheel brake cylinder outlet valves 50a and 52a, respectively. Connected downstream of the wheel brake cylinder outlet valves 50a and 52a is a common line 54a, to which a reservoir 56a is connected and which furthermore leads via a check valve 58a to the line 32a and the prechamber 34a of the pump 36a.

During the operation of the vehicle brake system of this kind, the reservoir 56a must be evacuated from time to time for operational reasons. The fill level of the reservoir 56a is estimated via a hydraulic model. At the same time, upon evacuation of the reservoir 56a, it must be assured that the reservoir is indeed full emptied. To compensate for any mistakes in estimation, the evacuation operation is therefore performed for longer than necessary. In the space between the high-pressure switching valve 28a and the pump 36a, a low pressure can then occur. In subsequent regulating interventions in the vehicle brake system 10, the high-pressure switching valve 28a can be opened in certain cases, causing the evacuated prechamber 34a in particular to be suddenly filled with hydraulic fluid. This filling operation leads to a loud noise and can cause dropping of the brake pedal. Customer complaints can be the consequence.

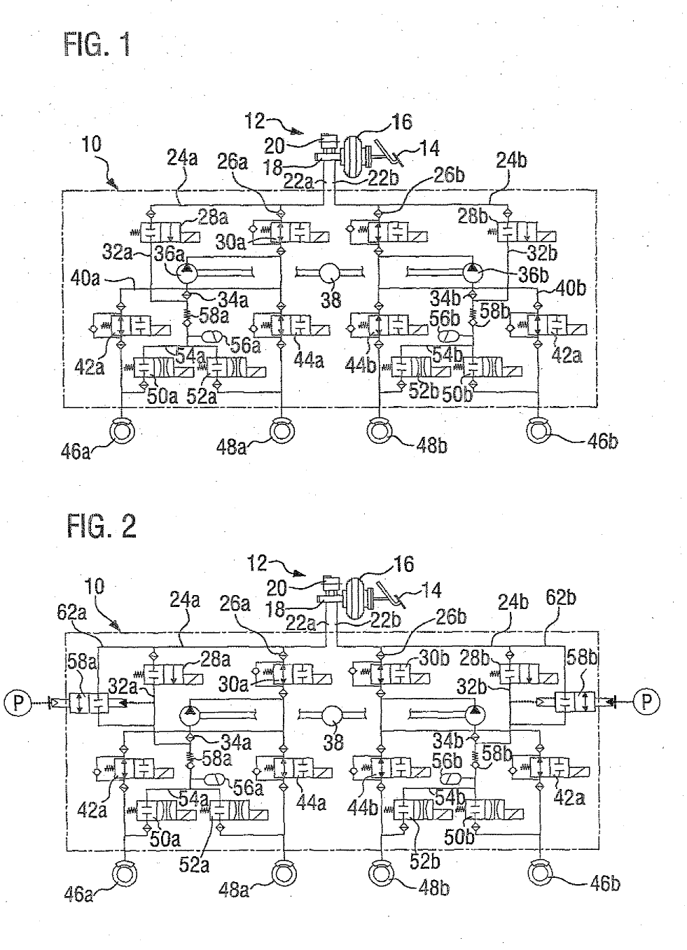

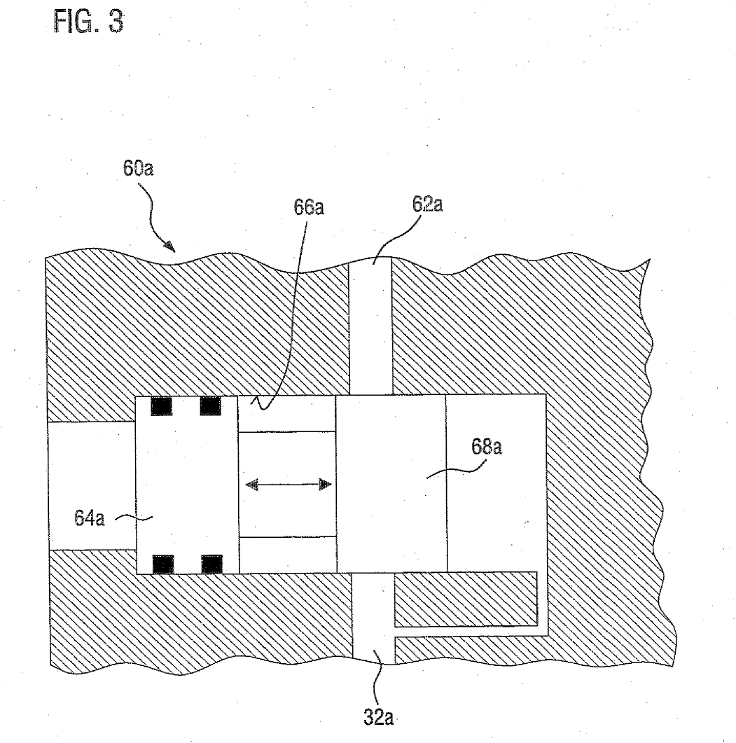

To avoid the aforementioned sudden filling, in the exemplary embodiment of the invention shown in FIG. 2, a bypass valve 60a in the line 62a is connected parallel to the high-pressure switching valve 28a (and correspondingly to a high-pressure switching valve 28b in the second brake circuit). The line 62a branches off from the line 24a and discharges into the line 32a.

The bypass valve 60a is shown in more detail in FIG. 3 and is provided with a first adjuster 64a, by means of which it can be moved in the direction of an open position by the ambient pressure, counter to the pressure prevailing in the line 32a or the prechamber 34a. For that purpose, the first adjuster 64a is designed as a sealed piston, which is displaceable in an opening 66a and at which ambient pressure prevails on one face end. The bypass valve 60a furthermore has a second adjuster 68a, which like the adjuster 64a is designed as a piston that is displaceable in the opening 66a. The pressure of the line 32a or prechamber 34a is carried to the face end of this piston, so that the adjuster 68a moves the bypass valve 60a into a closed position (shown in FIG. 3), counter to the ambient pressure.

The bypass valve 60a thus switches as a function of the pressure difference between the ambient pressure and the prechamber pressure of the vehicle brake system 10. An evacuation of the prechamber 34a is prevented by the bypass valve 60a, since the latter valve opens as soon as the pressure in the line 32a drops below the ambient pressure. The aforementioned sudden pressure equalization, which exists in the prior art, at the high-pressure switching valve is avoided in this way according to the invention.

### LIST OF REFERENCE NUMERALS

10 Vehicle brake system
12 Brake actuation unit
14 Brake pedal
16 Brake booster
18 Master cylinder
20 Brake fluid reservoir
22a/22b Line
24a/24b Line
26a/26b Line
28a/28b High-pressure switching valve
30a/30b Low-pressure switching valve
32a/32b Line
34a/34b Prechamber
36a/36b Pump
38 Motor
40a/40b Line
42a/42b Wheel brake cylinder inlet valve
44a/44b Wheel brake cylinder inlet valve
46a/46b Wheel brake
48a/48b Wheel brake
50a/50b Wheel brake cylinder outlet valve
52a/52b Wheel brake cylinder outlet valve
54a/54b Line
56a/56b Reservoir
58a/58b Check valve
60a/60b Bypass valve
62a/62b Line
64a/64b Adjuster
66a/66b Opening
68a/68b Adjuster

1-7. (canceled)

8. A vehicle brake system comprising a pump, a prechamber, from which the pump can aspirate a fluid, a switching valve by means of which fuel can be directed selectively to the prechamber, and a bypass valve connected parallel to the switching valve and switched as a function of the pressure difference between the ambient pressure and the prechamber pressure.

9. The vehicle brake system as defined by claim 8, further comprising a control unit operable to open the bypass valve if the prechamber pressure sinks below the ambient pressure and closes it again if the prechamber pressure rises to or above the ambient pressure.

10. The vehicle brake system as defined by claim 8, wherein the bypass valve comprises a first adjuster, the first adjuster been actuated by the ambient pressure to pneumatically open the bypass valve.

11. The vehicle brake system as defined by claim 9, wherein the bypass valve comprises a first adjuster, the first adjuster been actuated by the ambient pressure to pneumatically open the bypass valve.

12. The vehicle brake system as defined by claim 8, further compressing a second adjuster in the bypass valve the second adjuster being actuated by the prechamber pressure to hydraulically close the bypass valve.

13. The vehicle brake system as defined by claim 9, further compressing a second adjuster in the bypass valve the second adjuster being actuated by the prechamber pressure to hydraulically close the bypass valve.

14. The vehicle brake system as defined by claim 10, further compressing a second adjuster in the bypass valve the second adjuster being actuated by the prechamber pressure to hydraulically close the bypass valve.

15. The vehicle brake system as defined by claim 8, wherein the bypass valve is a slide valve.

16. The vehicle brake system as defined by claim 9, wherein the bypass valve is a slide valve.

17. The vehicle brake system as defined by claim 10, wherein the bypass valve is a slide valve.

18. The vehicle brake system as defined by claim 12, wherein the bypass valve is a slide valve.

19. The vehicle brake system as defined by claim 8, wherein the switching valve, together with the bypass valve define a high-pressure switching valve of a hydraulic brake system.

20. The vehicle brake system as defined by claim 9, wherein the switching valve, together with the bypass valve define a high-pressure switching valve of a hydraulic brake system.

21. The vehicle brake system as defined by claim 10, wherein the switching valve, together with the bypass valve define a high-pressure switching valve of a hydraulic brake system.

22. The vehicle brake system as defined by claim 12, wherein the switching valve, together with the bypass valve define a high-pressure switching valve of a hydraulic brake system.

23. The vehicle brake system as defined by claim 15, wherein the switching valve, together with the bypass valve define a high-pressure switching valve of a hydraulic brake system.

24. The vehicle brake system as defined by claim 8, further comprising a reservoir and a suction line leading from the reservoir to the pump, the prechamber being at least a part of the suction line.

25. The vehicle brake system as defined by claim 9, further comprising a reservoir, and a suction line leading from the reservoir to the pump, the prechamber being at least a part of the suction line.

26. The vehicle brake system as defined by claim 10, further comprising a reservoir, and a suction line leading from the reservoir to the pump, the prechamber being at least a part of the suction line.

27. The vehicle brake system as defined by claim 19, further comprising a reservoir, and a suction line leading from the reservoir to the pump, the prechamber being at least a pan of the suction line.
